(19) United States
(12) Patent Application Publication
(10) Pub. No.: US 2024/0375784 A1
(43) Pub. Date: Nov. 14, 2024

(54) AERIAL REFUELING SYSTEMS AND METHODS

(71) Applicant: The Boeing Company, Arlington, VA (US)

(72) Inventors: Joshua Neighbor, Seattle, WA (US); Justin Hatcher, Sumner, WA (US); Shawn Chamberlain, Federal Way, WA (US); Julian Ametsitsi, Lake Tapps, WA (US)

(21) Appl. No.: 18/314,653

(22) Filed: May 9, 2023

(51) Int. Cl. B64D 39/00; G05D 1/10; G06T 7/73

(52) U.S. Cl. CPC B64D 39/00; G06T 7/75; G06T 2207/10032

(57) ABSTRACT

A method for performing automated refueling operations includes receiving a two-dimensional (2D) image of a device associated with in-flight refueling operations between a receiver aircraft and a tanker aircraft, identifying keypoints on the device in the 2D image, projecting the keypoints to three-dimensional (3D) space to produce 3D keypoints, comparing the 3D keypoints to a previously stored 3D model of the device to produce a confidence value, and automatically controlling the refueling operations in response to the confidence value.

### FIELD

This disclosure relates generally to aerial refueling, and more particularly to controlling aerial refueling operation.

### BACKGROUND

Automation of aerial refueling provides safety benefits for the tanker aircraft and the receiver aircraft. However, accurately and efficiently conducting a refueling operation using cameras can be difficult when practicing current automated techniques.

### SUMMARY

The subject matter of the present application has been developed in response to the present state of the art, and in particular, in response to the shortcomings of conventional aerial refueling techniques, that have not yet been fully solved by currently available techniques. Accordingly, the subject matter of the present application has been developed to provide systems and methods for providing aerial refueling techniques that overcome at least some of the above-discussed shortcomings of prior art techniques.

The following is a non-exhaustive list of examples, which may or may not be claimed, of the subject matter, disclosed herein.

In one example, a method includes receiving a 2D image of a device associated with in refueling operations between a receiver aircraft and a tanker aircraft, identifying keypoints on the device in the 2D image, projecting the keypoints to 3D space to produce 3D keypoints, comparing the 3D keypoints to a previously stored 3D model of the device to produce a confidence value, and automatically controlling the refueling operations in response to the confidence value.

In another example, a tanker aircraft includes a camera configured to generate a two-dimensional (2D) image of a device associated with refueling operations between a receiver aircraft and the tanker aircraft, a processor, and non-transitory computer readable storage media storing code. The code is executable by the processor to perform operations including identifying keypoints on the device in the 2D image, projecting the keypoints to three-dimensional (3D) space to produce 3D keypoints, comparing the 3D keypoints to a previously stored 3D model of the device to produce a confidence value, and automatically controlling the refueling operations in response to the confidence value.

In yet another example, an automated refueling system includes a camera configured to generate a 2D image of a device associated with refueling operations between a receiver aircraft and a tanker aircraft, a processor, and non-transitory computer readable storage media storing code. The code is executable by the processor to perform operations includes identifying keypoints on the device in the 2D image, projecting the keypoints to 3D space to produce 3D keypoints, comparing the 3D keypoints to a previously stored 3D model of the device to produce a confidence value, and automatically controlling the refueling operations in response to the confidence value.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which:

FIG. 1 is a schematic block diagram of a tanker aircraft with an automated director light system, according to one or more examples of the present disclosure;

FIG. 2 is a schematic, perspective view of an image of a aircraft refueling operation, according to one or more examples of the present disclosure;

FIG. 3 is a schematic, side elevation view of an aircraft refueling operation, according to one or more examples of the present disclosure;

FIG. 4 is a schematic, bottom view of an aircraft refueling operation, according to one or more examples of the present disclosure;

FIG. 5 is a schematic view of an aircraft refueling boom operator display, according to one or more examples of the present disclosure;

FIG. 6 is a schematic, perspective view of a two-dimensional points projected to three-dimensional space, according to one or more examples of the present disclosure;

FIG. 7 is a schematic, perspective view of keypoint comparisons, according to one or more examples of the present disclosure; and

FIG. 8 is a schematic flow diagram of a method of automatically controlling refueling operations, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

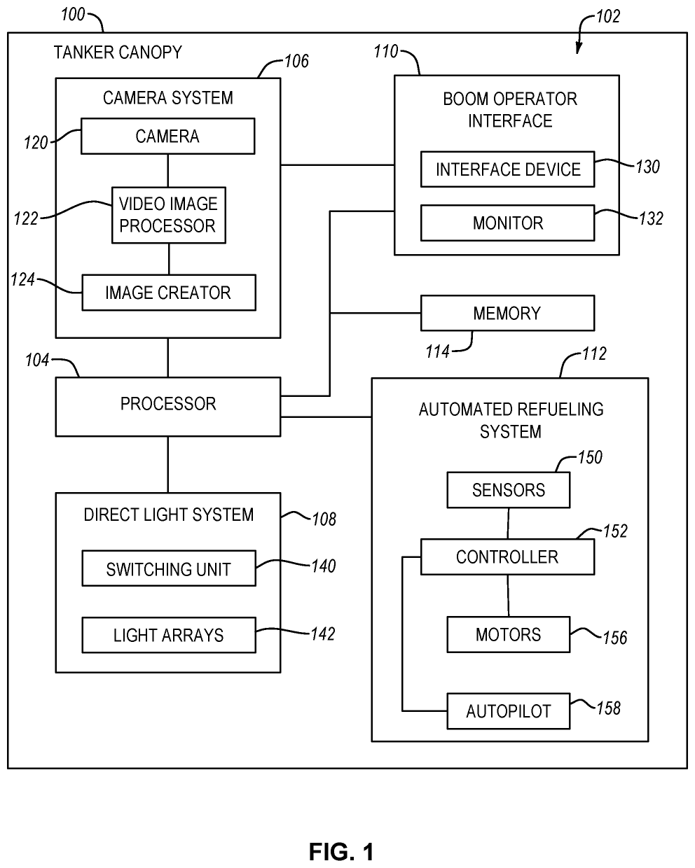

Disclosed herein is a refueling system 102 located on a tanker aircraft 100 that provides improved reliable aerial refueling information, which can be supplied to receiver aircraft pilots, boom operators, and/or an automated aerial refueling components during an aircraft approach to a refueling hookup position. As shown in FIG. 1, the refueling system 102 includes a processor 104, a camera system 106, a director light system 108, a boom operator interface 110, an automated refueling system 112, and memory 114.

In various embodiments, the camera system 106 includes a camera 120, a video image processor 122, and an image generator 124. The camera 120 is mounted approximately to a fixed platform within a fared housing attached to the lower aft fuselage of the tanker aircraft 100. The camera 120 includes a lens or lenses having remotely operated focus and zoom capability. The camera 120 is located aft and below the tanker aircraft 100.

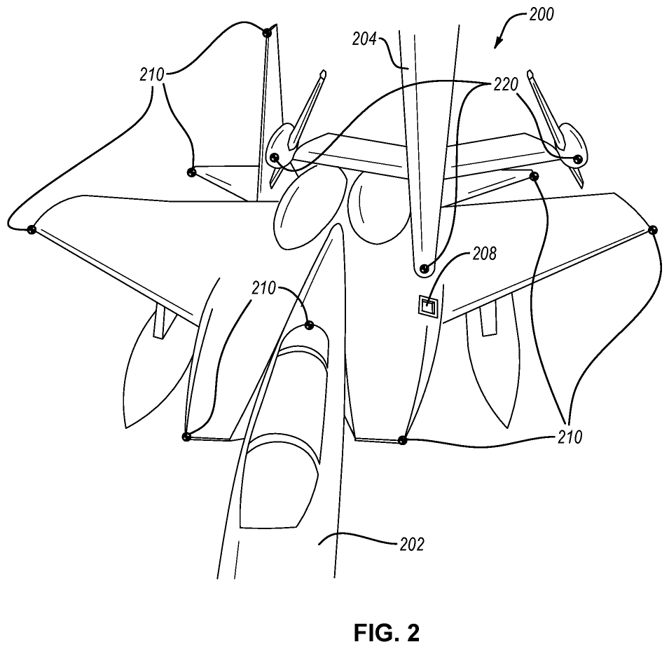

Referring to FIG. 2, the camera system 106 produces a two-dimensional (2D) image 200 of a three-dimensional space including a deployed refueling boom 204 and a receiver aircraft 202. The 2D image 200 includes an approach zone the receiver aircraft 202 enters into prior to beginning refueling operations. The receiver aircraft 202 includes a boom nozzle receiver 208 capable of coupling to the refueling boom 204 in order to accomplish fuel transfer.

In various embodiments, the boom operator interface 110 includes a user interface device 130 and a monitor 132. The director light system 108 includes a switching unit 140 and an array of lights 142 (i.e., pilot director lights).

In various embodiments, the automated refueling system 112 includes sensors 150, a controller 152, motors 156, and an autopilot system 158. The motors 156 provide motion to various parts of a refueling boom 204. The sensors 150 sense position of the tanker aircraft 100 and/or the refueling boom 204. The controller 152 controls the motors 156 responsive to signals received from the sensors 150. The controller 152 also controls operation of the motors 156 and/or produces directional control signals for the autopilot system 158 based on signals received from the processor 104. The processor 104 generates alert/warning signals and/or disengagement instructions based on a determined confidence value by analyzing images captured by the camera 120 and comparing the captured images to previous machine learned models of the receiver aircraft 202 or the refueling boom 204. The comparison is described in more detail below. Based on the alert/warning signals and/or disengagement instructions, the controller 152 instructs/commands the motors 156 and/or the autopilot system 158 to navigate the refueling boom 204 and/or the tanker aircraft 100 to a disengagement position.

It can be appreciated that refueling or close quarter operations may occur between other vehicles not just the aircraft 100, 202 depicted. The vehicles may be any vehicles that move in a space (in water, on land, in air, or in space). The vehicles may also be manned or unmanned. Given by way of a non-limiting example only, in various embodiments, the vehicles may be a motor vehicle driven by wheels and/or tracks, such as, without limitation, an automobile, a truck, a cargo van, and the like. Given by way of further non-limiting examples, in various embodiments, the vehicles may include a marine vessel such as, without limitation, a boat, a ship, a submarine, a submersible, an autonomous underwater vehicle (AUV), and the like. Given by way of yet further non-limiting examples, in various embodiments, the vehicles may include other manned or unmanned aircraft such as, without limitation, a fixed wing aircraft, a rotary wing aircraft, and a lighter-than-air (LTA) craft.

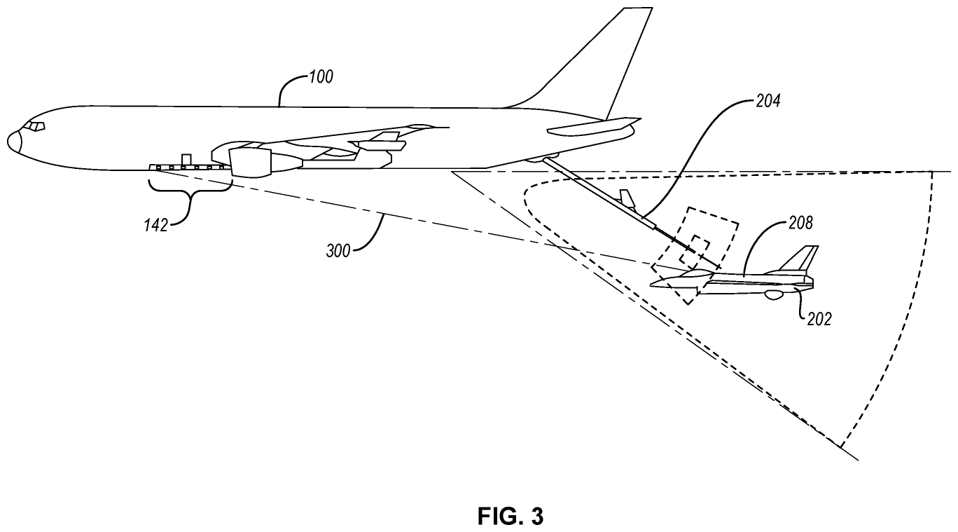

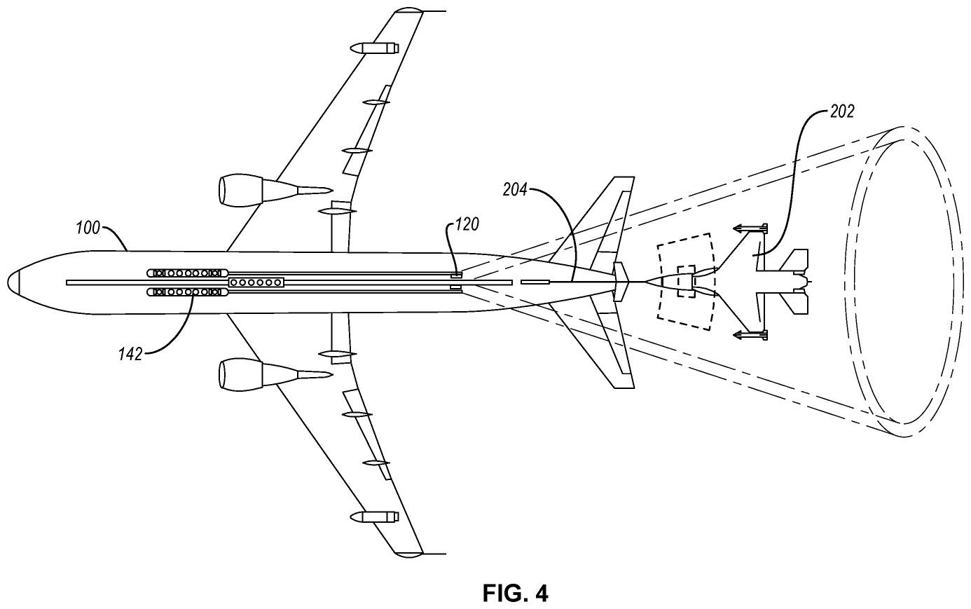

In various embodiments, referring to FIGS. 3 and 4, the array of lights 142 is located on the lower forward fuselage of the tanker aircraft 100. The array of lights 142 is positioned to be clearly viewable by the pilot of the receiver aircraft 202, as shown by line 300. The array of lights 142 include various lights for providing directional information to the pilot of the receiver aircraft 202. The array of lights 142 may include an approach light bar, an elevation light bar, a fore/aft position light bar, four longitudinal reflectors, two lateral reflectors, or other lights.

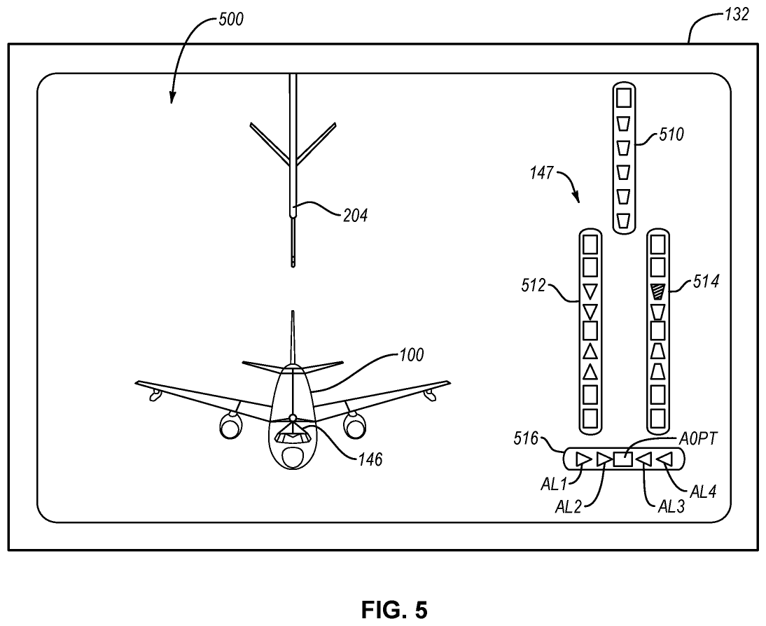

Referring to FIG. 5, in various embodiments, the boom operator monitor 132 displays an image 500. The image 500 includes data generated by the camera system 106, a selected geometric aircraft model 146, an image 147 of the pilot viewed array of lights 142, and an azimuth light bar 516. The image 500 includes the objects present in the field of view of the camera 120, specifically, an image of the refueling boom 204 and an image of the tanker aircraft 100. The image of the pilot viewed array of lights 142 includes a first light bar 510 that corresponds to an approach light bar, a second light bar 512 that corresponds to an elevation light bar, and a third light bar 514 that corresponds to a fore/aft light bar. The azimuth light bar 516 supplies the boom operator with information regarding lateral aircraft receptacle position relative to an optimum refueling position. The azimuth light bar 516 is displayed as a generated image horizontally only on the boom operator monitor 132. In the illustrated embodiment, the azimuth light bar 516 includes triangular lights AR1, AR2, AL3 and AL4 and a rectangular light AOPT. Located at the right side of the azimuth light bar 516 are lights AL3 and AL4 which point to the left. Light AL3 is further left than AL4. Lights AR1 and AR2 are located to the left. Light AR2 is further right than AR1 and lights AR1 and AR2 point to the right. Lights AR1, AR2, AL3 and AL4 are amber or yellow colored. Green colored light AOPT is located between AR2 and AL3.

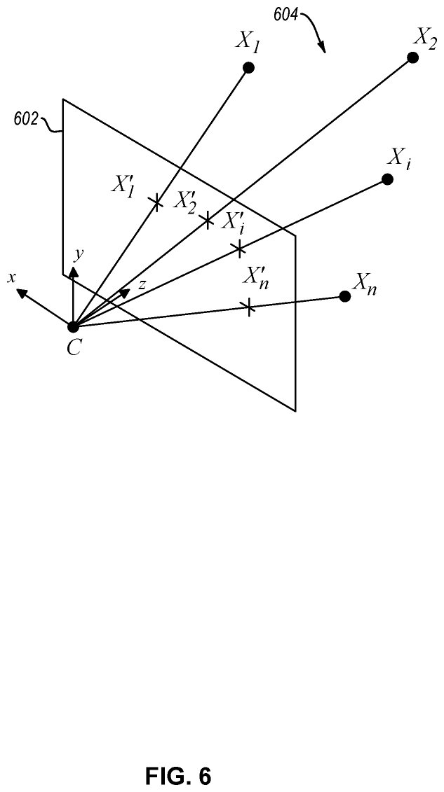

In various embodiments, non-transitory computer readable instructions (i.e., code) stored in the memory 114 (i.e., storage media) cause the processor 104 to predict keypoints 220 (FIG. 2) of the receiver aircraft 202 or keypoints 220 (FIG. 2) of the boom 204 within the 2D image 200. The keypoints 210, 220 are referenced in 2D space 602 (FIG. 6). The processor 104 then performs 2D to 3D correspondence by projecting the 2D keypoints 210, 220 into 3D space. Each of the predicted 2D keypoints 210, 220 are projected from 2D space 602 to 3D space 604 (FIG. 6) using a perspective-n-point pose computation. This produces an estimate of the position of the receiver aircraft 202 and/or the boom 204.

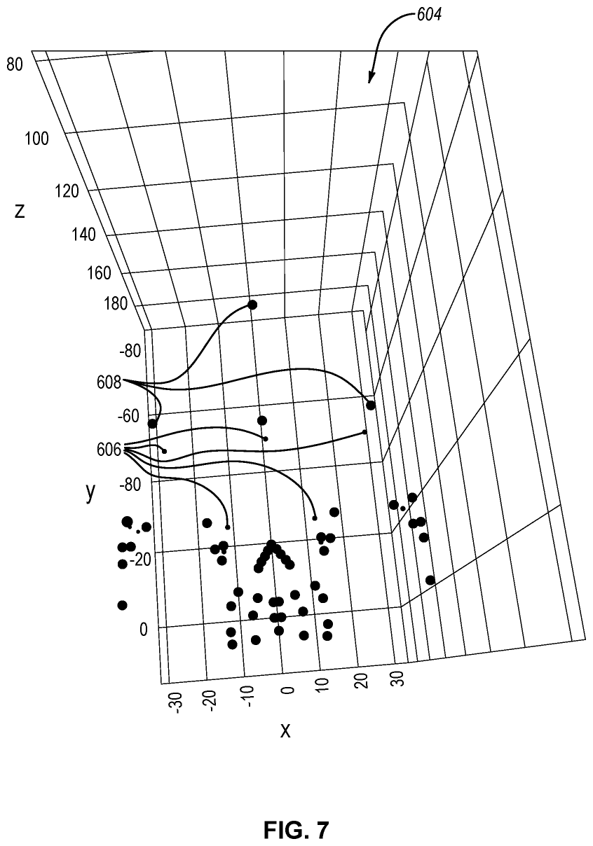

Referring to FIG. 7, in various embodiments, the processor 104 builds a confidence value of the predicted 2D keypoints 210, 220 by comparing/relating them to 3D keypoints of a known 3D digital model of the receiver aircraft 202. The comparing identifies various geometric relationships between the projected 3D keypoints 606 and the 3D model keypoints 608. An example geometric relationship is a true angle relationship between the 3D model keypoints and angles of the projected 3D keypoints. Another example includes geometric relationships between features on the aircraft 202. Observable/discernable aircraft features are selected as keypoints. The keypoints have known relationships with each other. For example, keypoint 1 is some known distance from keypoint 2 with a known angle between the two keypoints. So there is some known vector between keypoint 1 and keypoint 2. A machine learning (ML) model of predicted keypoints, when projected back into 3D space should have a similar relationship. So, if the vector between estimated keypoint 1 and estimated keypoint 2 is very different (greater than a threshold) than the known vector relationship then the trust (i.e., confidence value) in the ML model prediction of those points may be unacceptable to continue refueling operations. In one example, the amount that the keypoints 606 diverge from corresponding keypoints 608 or an average that all the keypoints 606 diverge produces a confidence value. If the confidence value drops below a predefined threshold level, the processor 104 determines that there is a need to discontinue the refueling operation, thereby commanding the directing light system 108, the boom operator interface 110, the automated refueling system 112, and/or the receiver aircraft 202 to discontinue refueling operations.

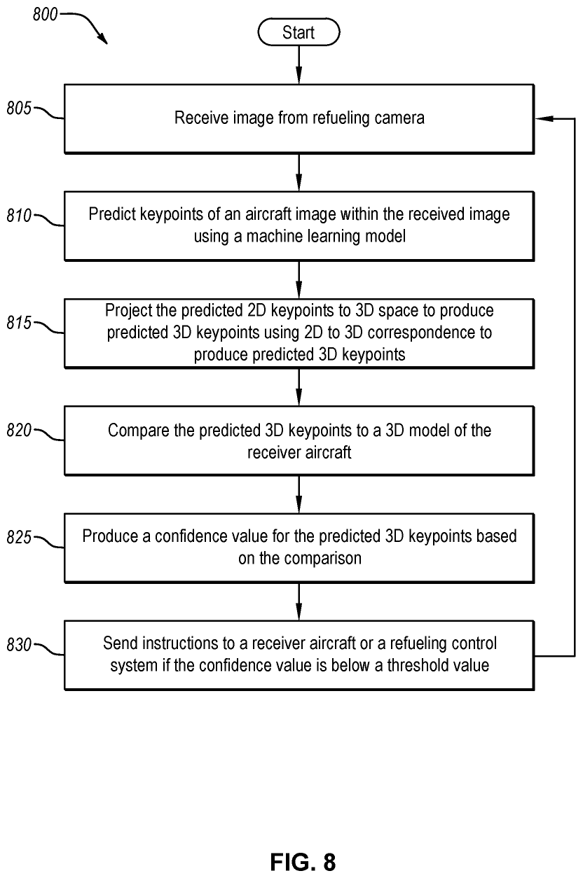

Referring to FIG. 8, a method 800 includes automatically sending instructions to a receiver aircraft or automatically controlling an automated refueling system. The block 805 includes receiving image from a refueling camera. The block 810 predicting keypoints of an image of a refueling aircraft or a refueling boom within the received image. The block 815 includes projecting the predicted 2D keypoints to 3D space to produce predicted 3D keypoints using 2D to 3D correspondence to produce predicted 3D keypoints. The block 820 includes comparing a geometric relationship(s) of the predicted 3D keypoints relative to keypoints on a 3D digital model of the receiver aircraft. The block 825 includes producing a confidence value for the predicted 3D keypoints based on the comparison. The block 830 includes sending instructions to the receiver aircraft or a refueling control system to either instruct the pilot of the receiver aircraft to disengage from refueling or control a refueling control system to navigate the refueling boom and/or a tanker aircraft to a disengagement position.

The following is a non-exhaustive list of examples, which may or may not be claimed, of the subject matter, disclosed herein.

The following portion of this paragraph delineates example 1 of the subject matter, disclosed herein. According to example 1, a method includes receiving a 2D image of a device associated with refueling operations between a receiver aircraft and a tanker aircraft, identifying keypoints on the device in the 2D image, projecting the keypoints to 3D space to produce 3D keypoints, comparing the 3D keypoints to a previously stored 3D model of the device to produce a confidence value, and automatically controlling the refueling operations in response to the confidence value.

The following portion of this paragraph delineates example 2 of the subject matter, disclosed herein. According to example 2, which encompasses example 1, above, the device is the receiver aircraft.

The following portion of this paragraph delineates example 3 of the subject matter, disclosed herein. According to example 3, which encompasses example 1, above, the device is a refueling boom.

The following portion of this paragraph delineates example 4 of the subject matter, disclosed herein. According to example 4, which encompasses any of examples 1-3, above, projecting the keypoints to 3D space is based on a 2D to 3D correspondence model.

The following portion of this paragraph delineates example 5 of the subject matter, disclosed herein. According to example 5, which encompasses any of examples 1-4, above, comparing includes determining one or more geometric relationships between the keypoints projected to 3D space and keypoints on a 3D digital model associated with the receiver aircraft and producing the confidence value based on the one or more geometric relationships.

The following portion of this paragraph delineates example 6 of the subject matter, disclosed herein. According to example 6, which encompasses any of examples 1-5, above, automatically controlling the refueling operations includes disengaging the refueling operations, if the confidence value is below a predefined threshold.

The following portion of this paragraph delineates example 7 of the subject matter, disclosed herein. According to example 7, which encompasses example 6, above, disengaging the refueling operations includes controlling pilot director lights.

The following portion of this paragraph delineates example 8 of the subject matter, disclosed herein. According to example 8, which encompasses any of examples 6 or 7, above, disengaging the refueling operations includes controlling an image presented on a boom operator monitor.

The following portion of this paragraph delineates example 9 of the subject matter, disclosed herein. According to example 9, which encompasses any of examples 6-8, above, the device is a refueling boom and disengaging the refueling operations includes moving the refueling boom to a boom disengagement position or navigating the tanker aircraft to an aircraft disengagement position.

The following portion of this paragraph delineates example 10 of the subject matter, disclosed herein. According to example 10, a tanker aircraft includes a camera configured to generate a 2D image of a device associated with refueling operations between a receiver aircraft and the tanker aircraft, a processor, and non-transitory computer readable storage media storing code. The code is executable by the processor to perform operations comprising: identifying keypoints on the device in the 2D image; projecting the keypoints to 3D space to produce 3D keypoints; comparing the 3D keypoints to a previously stored 3D model of the device to produce a confidence value; and automatically controlling the refueling operations in response to the confidence value.

The following portion of this paragraph delineates example 11 of the subject matter, disclosed herein. According to example 11, which encompasses example 10, above, the aircraft further includes a refueling boom. The device is the receiver aircraft or the refueling boom.

The following portion of this paragraph delineates example 12 of the subject matter, disclosed herein. According to example 12, which encompasses example 10, above, projecting the keypoints to 3D space is based on a 2D to 3D correspondence model.

The following portion of this paragraph delineates example 13 of the subject matter, disclosed herein. According to example 13, which encompasses any of examples 10-12, above, the code is executable by the processor to determine one or more geometric relationships between the keypoints projected to 3D space and keypoints on a 3D digital model associated with the receiver aircraft and produce the confidence value based on the one or more geometric relationships.

The following portion of this paragraph delineates example 14 of the subject matter, disclosed herein. According to example 14, which encompasses any of examples 10-13, above, the aircraft includes an automated refueling system. Automatically controlling the refueling operations comprises instructing the automated refueling system to disengage the refueling operations, if the confidence value is below a predefined threshold.

The following portion of this paragraph delineates example 15 of the subject matter, disclosed herein. According to example 15, which encompasses example 14, above, the aircraft further includes pilot director lights, a boom operator monitor, a controller, and an autopilot system. Disengaging the refueling operations includes controlling the pilot director lights, controlling an image presented on the boom operator monitor, instructing the controller to move the refueling boom to a boom disengagement position, or instructing the autopilot system to navigate the aircraft to an aircraft disengagement position.

The following portion of this paragraph delineates example 16 of the subject matter, disclosed herein. According to example 16, an automated refueling system includes a camera configured to generate a 2D image of a device associated with refueling operations between a receiver aircraft and a tanker aircraft, a processor, and non-transitory computer readable storage media storing code. The code being executable by the processor to perform operations includes identifying keypoints on the device in the 2D image, projecting the keypoints to 3D space to produce 3D keypoints, comparing the 3D keypoints to a previously stored 3D model of the device to produce a confidence value, and automatically controlling the refueling operations in response to the confidence value.

The following portion of this paragraph delineates example 17 of the subject matter, disclosed herein. According to example 17, which encompasses example 16, above, the device is the receiver aircraft or a refueling boom.

The following portion of this paragraph delineates example 18 of the subject matter, disclosed herein. According to example 18, which encompasses any of examples 16 or 17, above, projecting the keypoints to 3D space is based on 2D to 3D correspondence model.

The following portion of this paragraph delineates example 19 of the subject matter, disclosed herein. According to example 19, which encompasses any of examples 16-18, above, comparing includes determining one or more geometric relationships between the keypoints projected to 3D space and keypoints on a 3D digital model associated with the receiver aircraft and producing the confidence value based on the one or more geometric relationships.

The following portion of this paragraph delineates example 20 of the subject matter, disclosed herein. According to example 20, which encompasses any of examples 16-19, above, automatically controlling the refueling operations includes controlling pilot director lights, controlling an image presented on a boom operator monitor, controlling the refueling boom 204 to move to a boom disengagement position, or controlling the tanker aircraft 100 to navigate to an aircraft disengagement position.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Those skilled in the art will recognize that at least a portion of the controllers, devices, units, and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller/processor, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit/processor or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise. The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A method comprising:
receiving a two-dimensional (2D) image of a device associated with refueling operations between a receiver aircraft and a tanker aircraft;
identifying keypoints on the device in the 2D image;
projecting the keypoints to three-dimensional (3D) space to produce 3D keypoints;
comparing the 3D keypoints to a previously stored 3D model of the device to produce a confidence value; and
automatically controlling the refueling operations in response to the confidence value.

2. The method of claim 1, wherein the device is the receiver aircraft.

3. The method of claim 1, wherein the device is a refueling boom.

4. The method of claim 1, wherein projecting the keypoints to 3D space is based on a 2D to 3D correspondence model.

5. The method of claim 1, wherein comparing comprises:
determining one or more geometric relationships between the 3D keypoints and keypoints on a 3D digital model associated with the receiver aircraft; and
producing the confidence value based on the one or more geometric relationships.

6. The method of claim 1, wherein automatically controlling the refueling operations comprises disengaging the refueling operations, if the confidence value is below a predefined threshold.

7. The method of claim 6, wherein disengaging the refueling operations comprises controlling pilot director lights.

8. The method of claim 6, wherein disengaging the refueling operations comprises controlling an image presented on a boom operator monitor.

9. The method of claim 6, wherein:
the device is a refueling boom; and
disengaging the refueling operations comprises moving the refueling boom to a boom disengagement position or navigating the tanker aircraft to an aircraft disengagement position.

10. A tanker aircraft comprising:
a camera configured to generate a two-dimensional (2D) image of a device associated with refueling operations between a receiver aircraft and the tanker aircraft;
a processor; and
non-transitory computer readable storage media storing code, the code being executable by the processor to perform operations comprising:
identifying keypoints on the device in the 2D image;
projecting the keypoints to three-dimensional (3D) space to produce 3D keypoints;
comparing the 3D keypoints to a previously stored 3D model of the device to produce a confidence value; and
automatically controlling the refueling operations in response to the confidence value.

11. The tanker aircraft of claim 10, further comprising a refueling boom, wherein the device is the receiver aircraft or the refueling boom.

12. The tanker aircraft of claim 10, wherein projecting the keypoints to 3D space is based on a 2D to 3D correspondence model.

13. The tanker aircraft of claim 10, wherein the code is executable by the processor to:
determine one or more geometric relationships between the keypoints projected to 3D space and keypoints on a 3D digital model associated with the receiver aircraft; and
produce the confidence value based on the one or more geometric relationships.

14. The tanker aircraft of claim 11, further comprising an automated refueling system, wherein automatically controlling the refueling operations comprises instructing the automated refueling system to disengage the refueling operations, if the confidence value is below a predefined threshold.

15. The tanker aircraft of claim 14, further comprising:
pilot director lights;
a boom operator monitor;
a controller; and
an autopilot system,
wherein disengaging the refueling operations comprises:
controlling the pilot director lights;
controlling an image presented on the boom operator monitor;
instructing the controller to move the refueling boom to a boom disengagement position; or
instructing the autopilot system to navigate the aircraft to an aircraft disengagement position.

16. An automated refueling system comprising:
a camera configured to generate a two-dimensional (2D) image of a device associated with refueling operations between a receiver aircraft and a tanker aircraft;
a processor; and
non-transitory computer readable storage media storing code, the code being executable by the processor to perform operations comprising:
identifying keypoints on the device in the 2D image;
projecting the keypoints to three-dimensional (3D) space to produce 3D keypoints;
comparing the 3D keypoints to a previously stored 3D model of the device to produce a confidence value; and
automatically controlling the refueling operations in response to the confidence value.

17. The automated refueling system of claim 16, wherein the device is the receiver aircraft or a refueling boom.

18. The automated refueling system of claim 16, wherein projecting the keypoints to 3D space is based on 2D to 3D correspondence model.

19. The automated refueling system of claim 18, wherein comparing comprises:
determining one or more geometric relationships between the keypoints projected to 3D space and keypoints on a 3D digital model associated with the receiver aircraft; and
producing the confidence value based on the one or more geometric relationships.

20. The automated refueling system of claim 17, wherein automatically controlling the refueling operations comprises:
controlling pilot director lights;
controlling an image presented on a boom operator monitor;
controlling the refueling boom to move to a boom disengagement position; or
controlling the tanker aircraft to navigate to an aircraft disengagement position.
